(19) United States
(12) Patent Application Publication
(10) Pub. No.: US 2018/0212698 A1
(43) Pub. Date: Jul. 26, 2018

(54) Methods and Apparatus for Decoding DL PHY Channels in a Narrow Band System

(71) Applicant: MEDIATEK Singapore Pte. Ltd., Singapore (SG)

(72) Inventors: Feifei Sun, Beijing (CN); Lei Zhang, Beijing (CN); Kuhn-Chang Lin, Chiayi City (TW); Jeng-Yi Tsai, Hsinchu City (TW); Xiu-Sheng Li, Hsinchu City (TW)

(21) Appl. No.: 15/933,376

(22) Filed: Mar. 23, 2018

Related U.S. Application Data
(63) Continuation of application No. PCT/CN2016/101145, filed on Sep. 30, 2016.

(30) Foreign Application Priority Data
Sep. 30, 2015 (CN) 201510642009.7

(51) Int. Cl. H04J 11/00; H04B 1/66; H04L 5/00; H04B 7/12; H04W 72/04

(52) U.S. Cl. CPC H04J 11/0069; H04B 1/662; H04L 5/0053; H04B 7/12; H04W 72/0413; H04L 5/0048

(57) ABSTRACT

Apparatus and methods are provided for decoding DL PHY channels in a narrow band wireless system. In one novel aspect, the UE performs a cell search and determines a first location of a resource block carrying system signals, obtains a second location of a second resource block based on the first resource block, wherein the second resource block includes a format indicator, determines a DL transmission format based on the format indicator, and receives and decodes a first DL physical channel based on the DL transmission format. In one embodiment, the UE operates in either a standalone mode, an in-band mode, or a guard-band mode. The DL transmission format comprises an offset index from a middle/central frequency of the first resource block in the in-band mode or the guard-band mode. In another embodiment, the UE further decodes a second DL physical channel carrying the format indicator.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2016/101145, with an international filing date of Sep. 30, 2016, which in turn claims priority from China Application Number CN201510642009.7 entitled “SIGNAL TRANSMITTING AND RECEIVING” filed on Sep. 30, 2015. This application is a continuation of International Application PCT/CN2016/101145, which claims priority from China Application Number CN201510642009.7. International Application PCT/CN2016/101145 is pending as of the filing date of this application, and the United States is a designated state in International Application PCT/CN2016/101145. This application claims the benefit under 35 U.S.C. § 119 from China Application Number CN201510642009.7. The disclosure of each of the forgoing documents is incorporated herein by reference.

### TECHNICAL FIELD

The disclosed embodiments relate generally to wireless communication, and, more particularly, to methods and apparatus for decoding DL PHY channels in a narrow band system.

### BACKGROUND

Mobile data usage has been increasing at an exponential rate in recent years. The 5^{th} generation mobile communication system has gained an increasingly momentum. Different from the traditional 2G/3G/4G wireless systems, the 5G wireless system not only supports human users, but also provides much better support for machine type communication (MTC) devices. One particular type of MTC is called massive MTC (MMC). The massive MTC is characterized by low cost, deployed with massive number of devices, low requirement on the speed of data transmission and high tolerance to delays.

The long-term evolution (LTE) system has been supporting low cost MTC (LC-MTC) since R11. LTE has introduced category-0 type of user for the LC-MTC. The latest MTC devices can support only 1.4 MHz bandwidth. The development of narrow band internet of thing (NB IoT) further reduces the RF bandwidth to 180 KHz. Though the LTE devices are better positioned to support IoT, it still does not meet the 5G IoT requirement.

Improvements and enhancements are required for decoding DL PHY channels in a narrow band system to meet the ultra-reliable, high speed, low delay, and massive deployment requirements.

### SUMMARY

Apparatus and methods are provided for decoding DL PHY channels in a narrow band wireless system. In one novel aspect a method is provided, comprising: obtaining a first resource block by a user equipment (UE) in a wireless system, wherein the first resource block carries a first set of system signal(s) of a first system; obtaining a second resource block based on the location of the first resource block; obtaining a format indicator on a second resource block; determining a downlink (DL) transmission format based on the format indicator; and receiving and decoding a first DL physical channel of the first system based on the DL transmission format.

In one embodiment, the first set of system signals is for cell search. In one case, the first resource block comprises PSS and SSS, and the second resource block comprises MIB. In another case, the first resource block comprises PSS, and the second resource block comprises SSS. In a third case, the first resource block comprises PSS and SSS, and the second resource block comprises a signal from a pre-defined set wherein each signal of the predefined set is associated with one DL transmission format.

In another embodiment, UE obtains the format indicator on the second resource block by sequence detection within a pre-defined sequence set, where each sequence is associated with one DL transmission format; or obtaining the format indicator on the second resource block by energy detecting on the second resource block; or obtains the format indicator on the second resource block by decoding a second DL channel transmitting carrying system information on the second resource block.

In yet another embodiment, the DL transmission format includes one or more elements comprising an operation mode, a DL carrier spacing, a PRB index, a frame structure, a CP length, a transmission waveform, a pilot format, and an operating bandwidth. And the operation mode is one predefined format comprising a standalone mode, an in-band mode, and a guard-band mode.

For the in-band mode, the first resource block carrying the first set of system signal(s) for the first system resides inside a frequency band of a second system. For the guard-band mode, the first resource block carrying the first set of system signal(s) for the first system resides in a guard frequency band a second system. When the operation mode is the in-band mode or the guard-band mode, and wherein the DL transmission format further comprising an offset index from a center frequency of a second system.

In another novel aspect, an user equipment (UE), comprising: a radio frequency (RF) transceiver that transmits and receives radio signals in the wireless communication network; a first resource block circuit that obtains a first resource block by performing a cell search, wherein the first resource block carries a first set of system signals; a second resource block circuit that obtains a second location of a second resource block based on the first resource block, wherein the second resource block includes a format indicator; a downlink (DL) transmission format circuit that determines a DL transmission format based on the format indicator; and a physical channel circuit that receives and decodes a DL physical channel based on the DL transmission format.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a wireless network with NB IoT in accordance with embodiments of the current invention.

FIG. 2 shows flow chart of receiving DL signals and determining Dl transmission format by the UE according to the embodiments of this invention

FIG. 3A illustrates exemplary diagrams of resource mapping for carrying DL transmission format indicator in accordance with embodiments of the current invention.

FIG. 3B illustrates exemplary diagrams of resource mapping for carrying DL transmission format indicator in accordance with embodiments of the current invention.

FIG. 3C illustrates exemplary diagrams of resource mapping for carrying DL transmission format indicator in accordance with embodiments of the current invention.

FIG. 4A illustrates exemplary diagrams for different operation mode of a DL transmission format in accordance with embodiments of the current invention.

FIG. 4B illustrates exemplary diagrams for different operation mode of a DL transmission format in accordance with embodiments of the current invention.

FIG. 4C illustrates exemplary diagrams for different operation mode of a DL transmission format in accordance with embodiments of the current invention.

FIG. 5A illustrates an exemplary diagram of DL transmission format with a single resource PRB in accordance with embodiments of the current invention.

FIG. 5B illustrates an exemplary diagram of DL transmission format with multiple resource PRBs in accordance with embodiments of the current invention.

FIG. 6A illustrates an exemplary diagram of DL transmission format in accordance with embodiments of the current invention.

FIG. 6B illustrates an exemplary diagram of using the anchor frequency for guard band searching in accordance with embodiments of the current invention.

FIG. 7 illustrates an exemplary flow chart of the UE determining the operation mode in accordance with embodiments of the current invention.

FIG. 8 illustrates an exemplary flow chart of the UE determining the operation mode based on the format indicator carried in the synchronization signal in accordance with embodiments of the current invention.

FIG. 9 shows exemplary diagrams of the UE accessing the system through the anchor frequency with frequency hopping in accordance with embodiments of the current invention.

FIG. 10 illustrates an exemplary flow chart of the eNB transmitting DL signals and determining DL transmission format in accordance with embodiments of the current invention.

### DETAILED DESCRIPTION

Reference will now be made in detail to some embodiments of the invention, examples of which are illustrated in the accompanying drawings.

Machine type communication is a form of data communication that involves one or more entities that do not necessarily need human interaction. A service optimized for machine type communication differs from a service optimized for human-to-human (H2H) communication. Typically, MTC services are different from the current mobile network communication services because MTC services involve different market scenarios, pure data communication, lower cost and effort, and a potentially very large number of communicating terminals with little traffic per terminal. Therefore, it is important to distinguish low cost (LC) MTC from regular UEs. UE with bandwidth reduction (BR-UE) can be implemented with lower cost by reducing the buffer size, clock rate for signal processing, and so on.

The embodiments are described associated with Massive MTC(MMC) and LTE carriers, but not limitation. In the embodiments of this invention, “MMC carrier” is one description for simplification, and for the person skilled in the art, the MMC carrier could be named as MTC carrier, MMC cell, MTC cell, etc. and the operating mode is one example, and could be called as the transmission mode, operation mode, which is not limitation to the embodiments of this invention. In LTE R 13, the BW for IoT terminal is mim 180 kHz. One benefits is the cost is low. And another benefits is, the above BW and system bandwidth is good for the spectrum for MTC. For example, if the GSM system is out of market in the future, the 180 kHz BW is compatible of the current GSM system, so the 180 kHz BW of MTC carrier could be deployed in the current GSM band more easily. One of such MTC carrier is a stand alone MTC carrier, the mode transmitting or receiving data on the stand alone carrier is called as stand alone operating mode. In another aspect, the actual transmission BW of 180 kHz BW is the same as the actual transmission unit, resource block (RB). If the above MTC carrier is deployed inside the LTE system, and coexists with the original common channel, signals of LTE system. A first system deployed in a second system, and the system BW of the first system smaller then the second system is called as in band operating mode.

Beside, the 180 kHz BW of MTC carrier could be deployed on the guard band of the LTE system, for example, maintaining the LTE modulation scheme and numerology, the one or more resources block on the guard band of LTE system could be the 180 khz band. In another embodiment, the 180 khz could adopt a new MCS, or new numerology different from LTE, the numerology is for example, the carrier spacing, by filtering, making the spectrum mask meets the requirement of protocol. Virtual Resource Block(VRB) is one wireless resource definition in LTE system, wherein comprises: localized and distributed way. For one VRB pair, the two time slots in one subframe is allocated one VRB number. On DL allocation or UL grant comprises multiple basic blocks, for example, a set of PRB. In one embodiment, the MTC carriers could be with the same or different transmission format with LTE system, for example, the UL or DL, there could be different carrier spacings, for example, the MTC carrier spacing is 3.75 kHz.

One project of in band eMTC, one signal receiving antenna the min terminal RF BW is supported as 1.4 MHz, and the max 15 dbm coverage enhancement, 1 Mpbs data rate are supported too. In eMTC system, UE has a RF BW of 1.4 MHz, so the UE may detect the synchronization signal and MIB carried in the PBCH. In one way, the UE obtains the cell ID etc information to obtain the time-frequency resource, TBS, to decoding the SIB1. And the information to decoding other SIBs could be obtained from SIB1. Besides, the future 5G system could adopt multiple different transmission formats, and the different transmission formats could be designed for different requirements. For example, one transmission format could support ultra reliable requirement, and another transmission format supports high rate requirement, for example, wide band LTE system, mmWave(MMW) system. Yet another transmission format could support ultra low latency. Another transmission format supports Massive IoT equipment, etc. Different transmission formats could share one frame structure, or the frame structures for different transmission formats are compatible, may be deployed in the same frequency band, further to say, switch according the the requirements flexibly. The embodiments of this invention could be used in 5G communication system, or used to solve the problems of coexistence of 4G and 5G systems.

According the embodiments of this invention, methods and apparatus for transmission format detecting for the 180 khz BW are provided. For different MTC carrier deployments, this method could provide a unified method, to reduce the complexity of calculation, to reduce the cost of MTC terminal.

For the person skilled in the art, there are two phases in the transitional cell searching, first, obtaining the coarse cell Frequency/timing from the first synch signal, PSS, and then, obtaining the accurate cell identification and Frequency/timing information from the second synchronization signal. In the embodiments of this invention, frequency correction burst is introduced, for example used for correcting the frequency offset of carrier. One example for frequency correction burst that, the Frame Boundary (FB) of the GSM system, may be single tone on the central frequency point, on with fixed offset from the central frequency point. In the embodiments of this invention, in the cell search procedure, at least part of all if FB, PSS and SSS are used. For the cell search in the initial cell search and for switch purpose, the compositions of synchronization signal for cell search may be different.

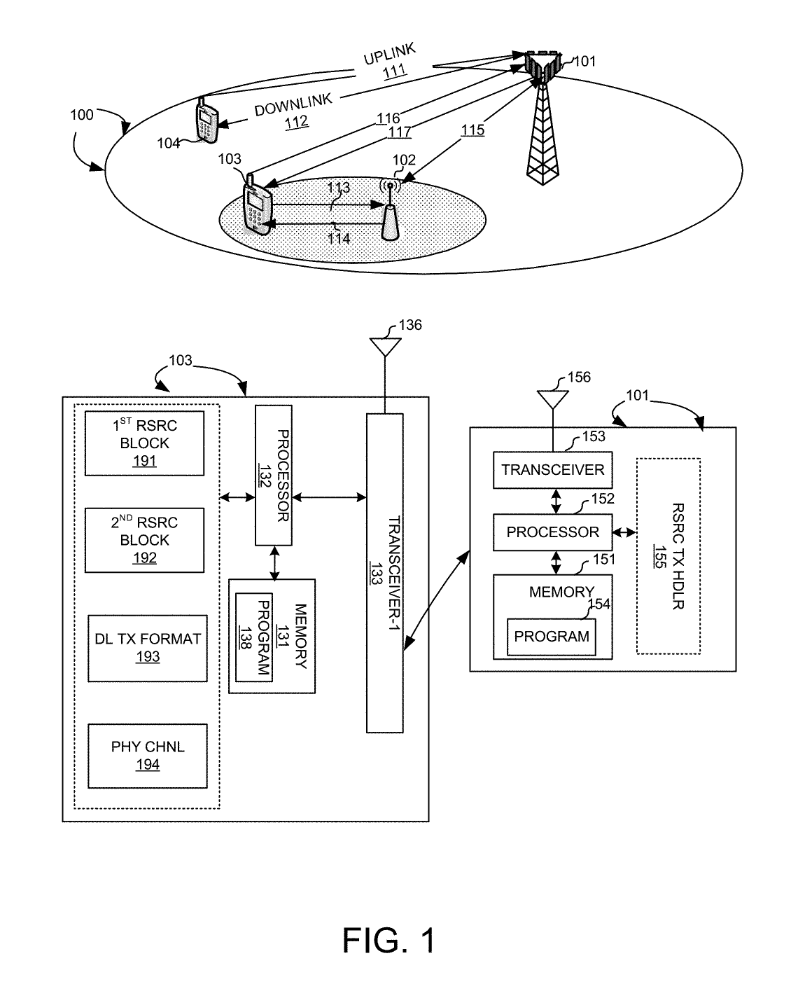

FIG. 1 illustrates a system diagram of a wireless network with NB IoT in accordance with embodiments of the current invention. Wireless communication system 100 includes one or more fixed base infrastructure units, such as base stations 101 and 102, forming a network distributed over a geographical region. The base unit may also be referred to as an access point, an access terminal, a base station, a Node-B, an eNode-B, or by other terminology used in the art. The one or more base stations 101 and 102 serve a number of mobile stations 103 and 104 within a serving area, for example, a cell, or within a cell sector. Base stations 101 and 102 can support different RATS. The two base stations simultaneously serve the mobile station 103 within their common coverage.

Base stations 101 and 102 transmit downlink communication signals 112, 114 and 117 to mobile stations in the time and/or frequency domain. Mobile station 103 and 104 communicate with one or more base stations 101 and 102 via uplink communication signals 111, 113 and 116.

In one novel aspect, the mobile stations are NB-IoT devices. They communicate with the base stations in NB by receiving DL transmission format information through signaling channels. The mobile stations further decode and connect with the base stations based on the received system information.

FIG. 1 further shows simplified block diagrams of base station 101 and mobile station 103 in accordance with the current invention. Base station 101 has an antenna 156, which transmits and receives radio signals. A RF transceiver module 153, coupled with the antenna, receives RF signals from antenna 156, converts them to baseband signals and sends them to processor 152. RF transceiver 153 also converts received baseband signals from processor 152, converts them to RF signals, and sends out to antenna 156. Processor 152 processes the received baseband signals and invokes different functional modules to perform features in eNB 101. Memory 151 stores program instructions and data 154 to control the operations of eNB 101. Base station 101 also includes a set of control modules such resource-transmission handler 155 circuit that handles the building and sending the DL transmission format information to the mobile stations.

Mobile station 103 has an antenna 136, which transmits and receives radio signals. A RF transceiver module 133, coupled with the antenna, receives RF signals from antenna 136, converts them to baseband signals and sends them to processor 132. RF transceiver 133 also converts received baseband signals from processor 132, converts them to RF signals, and sends out to antenna 136. Processor 132 processes the received baseband signals and invokes different functional modules to perform features in mobile station 103. Memory 131 stores program instructions and data 138 to control the operations of mobile station 103.

Mobile station 103 also includes a set of control modules that carry out functional tasks. A first resource block circuit 191 determines a first location of a first resource block by performing a cell search, wherein the first resource block carries a first set of system signals. A second resource block circuit 192 obtains a second location of a second resource block based on the first resource block, wherein the second resource block includes a format indicator. A downlink (DL) transmission format circuit 193 determines a DL transmission format based on the format indicator. A first physical channel circuit 194 receives and decodes a first DL physical channel based on the DL transmission format.

In one embodiment, the eNB can serve different kind of UEs. UE 103 and 104 may belong to different categories, such as having different RF bandwidth or different subcarrier spacing. UE belonging to different categories is be designed for different use cases or scenarios. For example, some use case such as Machine Type Communication (MTC) may require very low throughput, delay torrent, the traffic packet size may be very small (e.g., 1000 bit per message), extension coverage. Some other use case, e.g. intelligent transportation system, may be very strict with latency, e.g. orders of 1 ms of end to end latency. Different UE categories can be introduced for these diverse requirements. Different frame structures or system parameters may also be used in order to achieve some special requirement. For example, different UEs may have different RF bandwidths, subcarrier spacing values, omitting some system functionalities (e.g., random access, CSI feedback), or use physical channels/signals for the same functionality (e.g., different reference signals).

In one embodiment, the wireless communication system 100 utilizes an OFDMA or a multi-carrier based architecture including Adaptive Modulation and Coding (AMC) on the downlink and next generation single-carrier (SC) based FDMA architecture for uplink transmissions. SC based FDMA architectures include Interleaved FDMA (IFDMA), Localized FDMA (LFDMA), and DFT-spread OFDM (DFT-SOFDM) with IFDMA or LFDMA. In OFDMA based systems, UEs are served by assigning downlink or uplink radio resources that typically comprises a set of sub-carriers over one or more OFDM symbols. Exemplary OFDMA-based protocols include the developing Long Term Evolution (LTE) of the 3GPP UMTS standard and the IEEE 802.16 standard. The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two-dimensional spreading. In other embodiments, the architecture may be based on simpler time and/or frequency division multiplexing/multiple access techniques, or a combination of these various techniques. In alternate embodiments, the wireless communication system 100 may utilize other cellular communication system protocols including, but not limited to, TDMA or direct sequence CDMA.

For example, in the 3GPP LTE system based on SC-FDMA uplink, the radio resource is partitioned into subframes, and each of the subframes comprises 2 slots and each slot has 7 SC-FDMA symbols in the case of normal Cyclic Prefix (CP). For each user, each SC-FDMA symbol further comprises a number of subcarriers depending on the uplink assignment. The basic unit of the radio resource grid is called Resource Element (RE) which spans an SC-FDMA subcarrier over one SC-FDMA symbol.

Each UE gets an assignment, i.e., a set of REs in a Physical Uplink Shared Channel (PUSCH), when an uplink packet is sent from a UE to an eNB. The UE gets the downlink and uplink assignment information and other control information from its Physical Downlink Control Channel (PDCCH) or Enhanced Physical Downlink Control Channel (EPDCCH) whose content is dedicated to that UE. The uplink assignment is indicated in downlink control information (DCI) in PDCCH/EPDCCH. Usually, the uplink assignment indicated the resource allocation within one certain subframe, for example k+4 subframe if DCI is received in subframe k for FDD and for TDD, the timing relationship is given in a table in TS 36.213. TTI bundling is used in uplink transmission in LTE system to improve uplink coverage. If TTI bundle is enabled, one uplink assignment indicates several subframes to transmit one transport block using different redundancy version (RV).

Uplink control information is transmitted in Physical Uplink Control Channel (PUCCH) or transmitted with or without a transport block in PUSCH. UCI includes HARQ, scheduling request (SR), channel status information (CSI). PUCCH is allocated the border PRBs in uplink system bandwidth. Frequency diversity gain for PUCCH is obtained by frequency hopping between two slots in one subframe. Code Division Multiplexing (CDM) is used for PUCCH multiplexing between different UEs on the same radio resource.

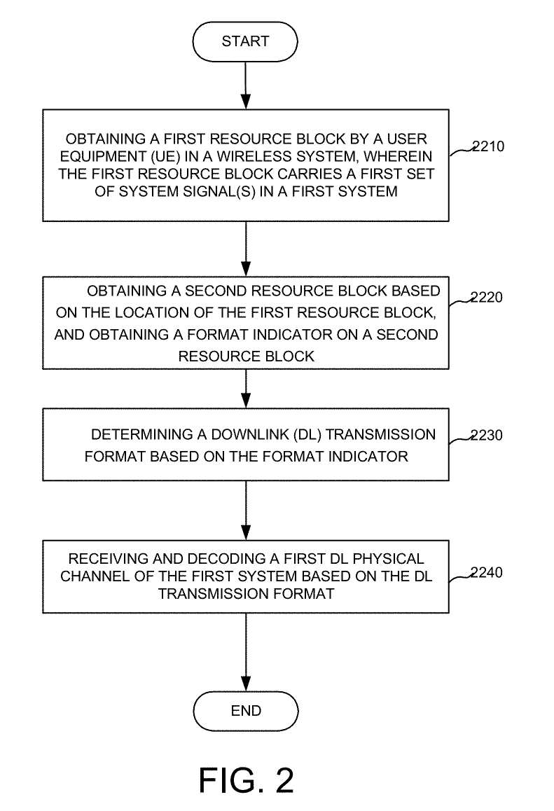

FIG. 2 shows flow chart of receiving DL signals and determining Dl transmission format by the UE according to the embodiments of this invention. In step 2210: UE obtains a first resource block by a user equipment (UE) in a wireless system, wherein the first resource block carries a first set of system signal(s) of a first system. In step 2220: UE obtains a second resource block based on the location of the first resource block, and obtains a format indicator on a second resource block. In step 2230: UE determines a downlink (DL) transmission format based on the format indicator. And in step 2240: UE receives and decodes a first DL physical channel of the first system based on the DL transmission format.

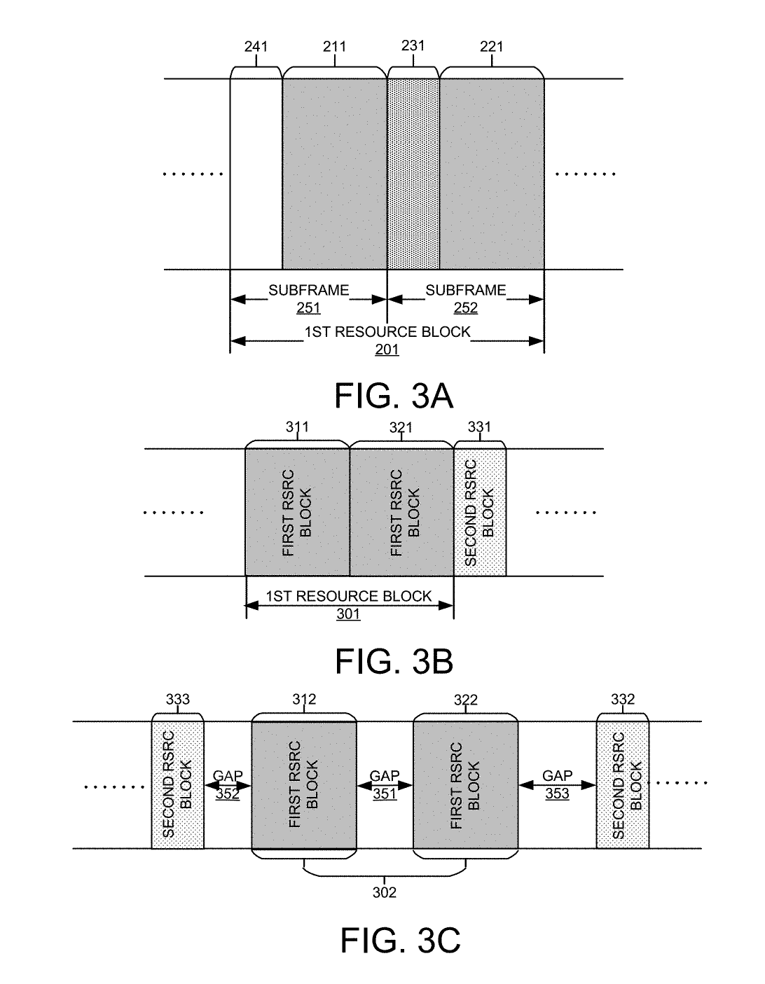

The said first resource block of step 2210 further comprises two or more resource sub-blocks. In one example, two or more resource sub-blocks are used for carrying the primary synchronization signal and second synchronization signal, and the first synchronization signal and second synchronization signal for example are PSS and SSS respectively. The synchronization signals are used for DL synchronization, or to provide estimation for frequency offset. The two or more resource sub-blocks are consecutive or not. Please refer to FIG. 3A-3C.

FIG. 3A illustrates an exemplary diagram of resource mapping for carrying DL transmission format indicator in accordance with embodiments of the current invention. A first resource block 201 includes two subframes 251 and 252. First resource block 201 has two non-consecutive sub-resource blocks 211 and 221, denoted by grey area, carrying the first set of synchronization signals and the second set of synchronization signals, respectively. In one example, the first set of synchronization signals and the second set of synchronization signals are PSS and SSS respectively. The A second resource block 231, which denoted by dotted area, is located between the two non-consecutive sub-resource blocks 211 and 221. The second resource block 231 carries the format indicator to determine the DL transmission format. In LTE Rel. 8, the DL control signal occupies the front part of the OFDM symbol, as shown in blocks 231 and 241. For example, each of blocks 231 and 241 may occupy two or three OFDM symbols. For the in-band operation mode, NB IoT system needs to avoid the LTE DL control signal. In one case, the first synchronization signals and the second synchronization signals are transmitted in two separate subframes, such as subframe 251 and subframe 252, to avoid to overlap the DL control channel 241 and 231. To reduce the complexity, some deployment modes may support single synchronization signal transmitting method. Therefore, for the guard band and standalone deployment, the same time difference could be maintained between the two synchronization signal. For the in band deployment, since the resource block 231 is used to transmit the LTE system DL control channel, it may not transmit the indicator for DL transmission format. The first resource block 201 has two non-consecutive sub-resource blocks 211 and 221, the resource may be used to transmit the indicator for DL transmission format. Accordingly, UE needs to detect the indicator. If the UE fails to detect the indicator, the UE determines DL transmission format is in band deployment for the cell.

FIG. 3B and FIG. 3C illustrate exemplary diagrams for the resource mapping carrying DL transmission format indicator in accordance with embodiments of the current invention. In the first example, please refer to FIG. 3B, a first resource block 301 includes has two consecutive sub-resource blocks 311 and 321, carrying the first set of synchronization signals and the second set of synchronization signals, respectively. A second resource block 331 is located adjacent to the first resource block 301. The second resource block 331 carries the format indicator to determine the DL transmission format. In a second example, please refer to FIG. 3C, the first resource block 302 includes has two non-consecutive sub-resource blocks 312 and 322, carrying the first set of synchronization signals and the second set of synchronization signals, respectively. The second resource blocks 333 and 332 are located before and after first resource block 302, respectively. The second resource blocks 333 and 332 carry the format indicator to determine the DL transmission format. There may be gaps between the resource blocks 333, 312, 322, and 322. In general, the first resource blocks may be consecutive resource blocks such as 311 and 321 in FIG. 3A. The first resource blocks can be non-consecutive blocks such as 312 and 322 in FIG. 3B. The second resource block may be adjacent to the first resource block, such as resource block 331 in FIG. 3A. The second resource blocks may be in front the first resource block with a gap, such as resource block 333 in FIG. 3B. The second resource blocks may be followed the first resource block with a gap, such as resource block 322 in FIG. 3B.

In the embodiments of FIG. 3A-3C, in one case, the first resource block comprises PSS and SSS, and the second resource block comprises MIB, in a second case, the first resource block comprises PSS, and the second resource block comprises SSS, in a third case, the first resource block comprises PSS and SSS, and the second resource block comprises a signal from a predefined set of signals, wherein each of the signal in the predefined set is associated with a DL transmission format. In a fourth case, UE obtains the format indicator on the second resource block by sequence detection within a pre-defined sequence set, where each sequence is associated with one DL transmission format.

Please refer back to FIG. 2, in step 2230, DL transmission formats comprise operating modes, for example standalone operating mode, in band operating mode, and guard band operating mode, wherein, the operating mode maybe in band operating mode or guard band operating mode, the DL transmission format carrying an frequency offset between central frequency point of the first resource block and the central frequency point of the second synchronization signal for the second system. In another embodiment, DL transmission format comprises DL carrier spacing or sub-carrier spacing, for example, one of the several carrier spacings, 15 kHz carrier spacing, or 3.75 kHz carrier spacing. Different carrier spacing are used for different deployment scenarios, for example, 15 kHz sub-carrier spacing is the same as LTE system, and is used for in band deployment or guard band deployment, respectively for in band operating mode and guard band operating mode. And maintaining the same carrier spacing may could obtain orthogonality and to avoid the interference. While the smaller sub-carrier spacing, for example 3.75 kHz sub-carrier spacing, could provide the longer CP under the same overhead, and guarantees the integer sampling points under the lower sampling frequency to reduce receiving complexity and power consumption. The small sub-carrier spacing may could be used for standalone deployment. In another embodiment, DL transmission format comprises CP length, or frame structure, or CP length and frame structure. Different frame structure, CP length could reduce receiving complexity. In another embodiment, DL transmission format comprises transmission waveform, for example single tone modulation, or multiple tone modulation. In another embodiment, DL transmission format comprises pilot format, pilot sequences, or location for pilot sequences.

In another example, DL transmission format comprises PRB index. Further, UE may utilize the PRB index to determine the operating mode, for example standalone operating mode, in band operating mode, guard band operating mode. For example, different PRB index are corresponding to different operating modes. Besides, UE needs PRB index to generate pilot signals, perform measurement or channel estimation for data demodulation. for example, for in band operating mode, UE needs the PRB index which the MTC carrier occupies, accordingly to generate LTE system CRS (cell-specific reference signal) based on the PRB index.

In the embodiments of this invention, DL transmission format may be indicated by the first synchronization signal (for example, PSS), second synchronization signal (SSS), DL broadcast signal(PBCH), or combination of the above. In option 1, first synchronization signal indicates the DL transmission format, for example, by different synchronization signal sequence with CDM or FDM, or CDM with FDM. In another option, different DL transmission formats adopt the same first synchronization signal, DL transmission format could be indicated by the combination of: time difference between different first synchronization signal and second synchronization signal, or second synchronization signal sequence, or second synchronization signal frequency domain action (e.g, frequency difference between the different first synchronization signal and second synchronization signal).

In one embodiment, DL transmission format is indicated by the information bits in PBCH. Besides, different CRC masks and different scrambling sequence in PBCH are used to indicate the different DL transmission modes. The above methods could be combined. To indicate the DL transmission formats. In NB-IoT or NB-LTE system, to differentiate the signals in legacy LTE system, PSS are called as common PSS(Common Primary Synchronization Signal, CPSS), SSS may called as common SSS(Common Secondary Synchronization Signal, CSSS), and PBCH may be called as common PBCH(Common Physical Broadcast Channel, CPBCH), to indicate the above signals are used for NB UEs.

The said format indicator in step 2220 may carried by a sequence. UE receives the signals on the second resource block location, detect s if the signals on the second resource block location are the known sequences. For example, the first sequence used to carry the bits for guard band operating mode, the second sequence carries the information about stand alone operating mode of the current cell, the third sequence carries the information about in band operating mode of the current cell. In another embodiment, if the UE does not detect the first sequence or the second sequence on the first resource block location of the second resource block location, it means that, the current cell is operating in the in band operation mode. Different sequences may indicate the different operating mode, for example, different sequence may indicate different PRB index or different sequence may indicate different sub-carrier spacing.

According to one novel aspect, at the beginning phase of cell search, UE searches for the guard band according to the guard band information stored on the UE side. For example, UE searches for the guard band according to at least one of the following the guard band information: the information stored on the UE side, the self searching result on the UE side. And in another example, the UE searches for the guard band not based on the self searching result on the UE side.

The information stored on the UE side could be stored on the SIM card, or any form of memory. The information stored on the UE side comprises frequency information, BW information, etc. UE performs cell search based on the observed energy in frequency domain. In other words, UE obtains the format indicator on the second resource block by energy detecting on the second resource block.

In option 1, UE detects anchor frequency to perform cell search. In option 2, UE blindly detects the guard band, in option 3, UE searches the guard band information based on the combination of information stored on the UE side and the blindly detection.

Here are some example of option 2:

In one case, because UE does not know the guard of the second system, for example, LTE. First UE performs energy scanning in frequency domain. If based on the observation in frequency domain, UE could be aware of the LTE carrier, and UE could identify the guard band of LTE. The LTE system is one example, the guard band could be the guard band of other system, and the guard band of LTE could be a candidate region.

In another case, UE detects the signal energy on the second resource block location to determine the Dl transmission format. For example, in the LTE in band deployment, synchronization signal, e.g. PSS, SSS may be in different subframes, and synchronization signal, e.g. PSS, SSS needs to avoid the front OFDMs symbols location with PDCCH transmission. For the guard band deployment or the stand-alone deployment, there are no PDCCH signals comprising PSS and SSS. Therefore, for the guard band or stand alone deployment, there are no signals transmitted on these locations. So UE could determine if it is in band deployment by energy detection. further, in band deployment, the guard band deployment and stand alone deployment are corresponding to different DL carrier spacings, for example, in band deployment adopts 15 kHzsub-carrier spacing, guard band deployment adopts 15 kHz sub-carrier spacing, stand alone deployment adopts 3.75 kHzsub-carrier spacing.

In another embodiment, UE may try to decode the second DL PHY channel on the second resource block, and determine the DL transmission format according to the decoding result. For example, UE may try to decode the second DL physical channel according to the predefined format, for example different CRC checks. If the decoding is successful, which means the CRC check passes.

In yet another embodiment, UE decodes the second Dl PHY channel on the second resource block according to the predefined format. Different information bits on the second DL physical channel indicate the different DL operating modes. In one case, the second DL physical channel may need CRC protection, in an alternative way, the second DL physical channel does not need CRC protection.

The same method may be used for determination of UL transmission format, for example, using the indicator to determine UL signals transmission waveform, or frame structure, or CP length, or sub-carrier spacing, or operating mode, PRB index, pilot format, operating band width, etc. In one example, different transmission formats may be used for different systems, these systems may share the same band, or part of the same band. For the first system, the cell search signals occupy the one resource block on the frequency point, wherein the other DL physical channels may occupy the resources on the same or different frequency points, and the operating bandwidth is the total of these resources on all the frequency points. For example, for the stand alone operating mode, after combining several bands, the UE performs DL channel transmission, wherein, the cell search signals only occupy one band of the BW, and the other PHY DL transmission may occupy one or more bands of the system BW. And UE could perform frequency hopping (FH) within these bands to obtain a big diversity gain, or to avoid the inter-cell interference. In yet another example, for in band operating mode, the whole bandwidth of the second system may be defined as the operating bandwidth.

When the first system is deployed on the guard band of the second system, the sum of in band and the guard bands of the first system is defined as the operating bandwidth, this deployment may be further defined as guard band operating mode and in band operating mode cooperation. Alternatively, when the guard band operating mode is deployed on the guard band of the second system, only the guard band BW is defined as the operating bandwidth of the first system. This depends on the band resources which the other DL PHY channels use. In another embodiment, UE could determine the UL transmission format based on the DL transmission format. for example, UL operating mode is corresponding to the DL transmission format, for example, UL and DL operating modes are the same stand alone operating mode, or in band operating mode, or guard band operating mode. DL 3.75 kHz carrier spacing is corresponding to the UL single tone transmission.

In step 2230, after UE determines DL transmission format according to the indicator, UE adjusts the receiver configuration to receive and decode DL physical channel according to the DL transmission format. For example, UE needs to adjust different FFT sizes corresponding to different sub-carrier spacing. UE needs to adjust receiver to adopt the different receiving operating mode, for example, different operating modes adopt different transmit powers, or different operating mode adopt different pilot patterns or sequences, or different operating mode adopt different CP lengths. UE needs to adjust the receiver to receive different carrier waveform. For example, the RF filter, pre-coder, antenna angle. Accordingly, if UE could determine UL transmission format according to the indicator, UE needs to adjust the transmitter configuration to transmit UL PHY channels.

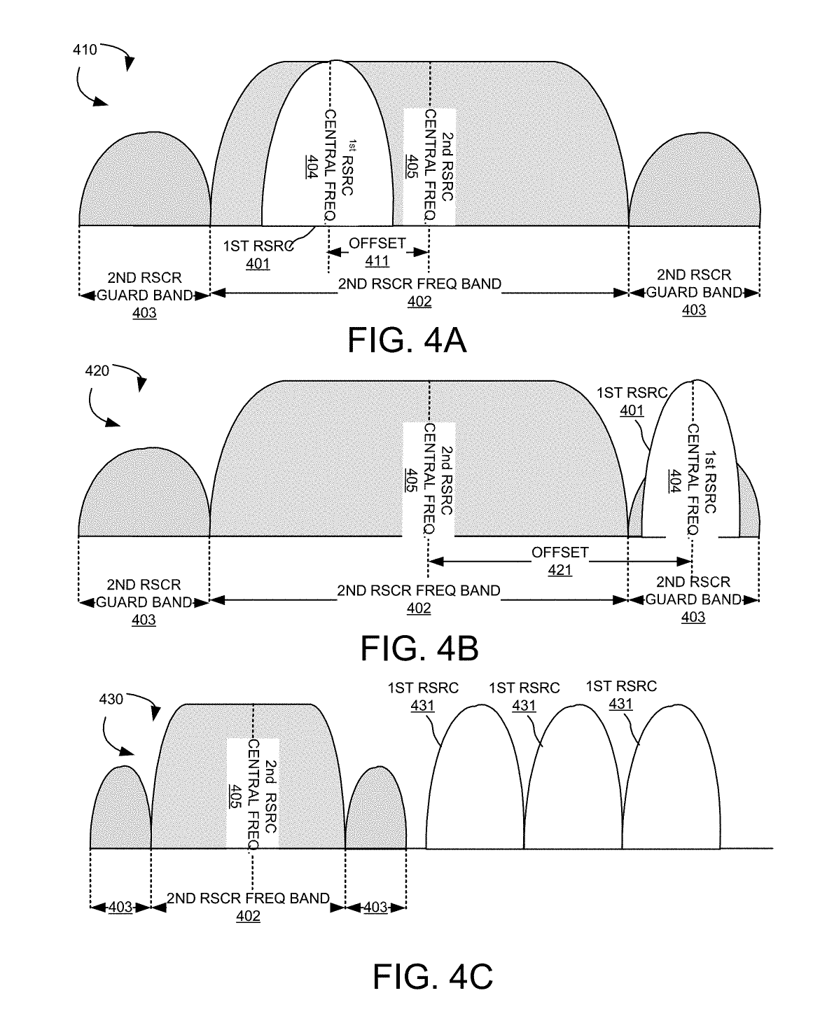

FIG. 4A-4C illustrate exemplary diagrams for different operation mode of a DL TX format in accordance with embodiments of the current invention. FIG. 4A-4C illustrate an in-band operation mode 410, a guard-band operation mode 420, and a standalone operation mode 430. In FIG. 4A, the first resource block carrying the first set of system signal(s) for the first system resides inside a frequency band of a second system, so it is called the in-band mode. Please refer to FIG. 4A, a first system 401 has a central frequency/middle frequency 404. A second system has a resource frequency band 402 and the resource guard band 403. The resource frequency band 402 has a central frequency/middle frequency 405. An offset 411 indicates the gap between central frequency 404 and 405. In the in-band operation mode 410, the resource of first system 401 is within the frequency band of the second system 402. Please refer to FIG. 4B, in the guard-band operation mode 420, the resource of the first system 401 is located within the guard band of the second system 402, for example, the resource 403. Please refer to FIG. 4C, in the standalone operation mode 430, the first system 431 of the first system are outside the frequency band of the second system 402 and are out the guard band 403 as well. The first system 431 is transmitted on the independent carrier. For example, the NB IoT signal is transmitted independently using GSM refarming band. In one embodiment, the DL transmission format includes the offset index from the middle frequency of the first system to the middle frequency of the second system.

In one case, for example, the first system is the NB-IoT system, and the second system is the LTE system. In LTE, the pilot signals can be used to decode the physical channel, measure the channel condition, and estimate the frequency offset. For the in-band operation mode, in order to reuse the pilot signals of the LTE system, UE needs to obtain the PRB index, which the DL PHY channel of LTE system occupies. And the pilot signals of the LTE system is generated by the PRB index in LTE system.

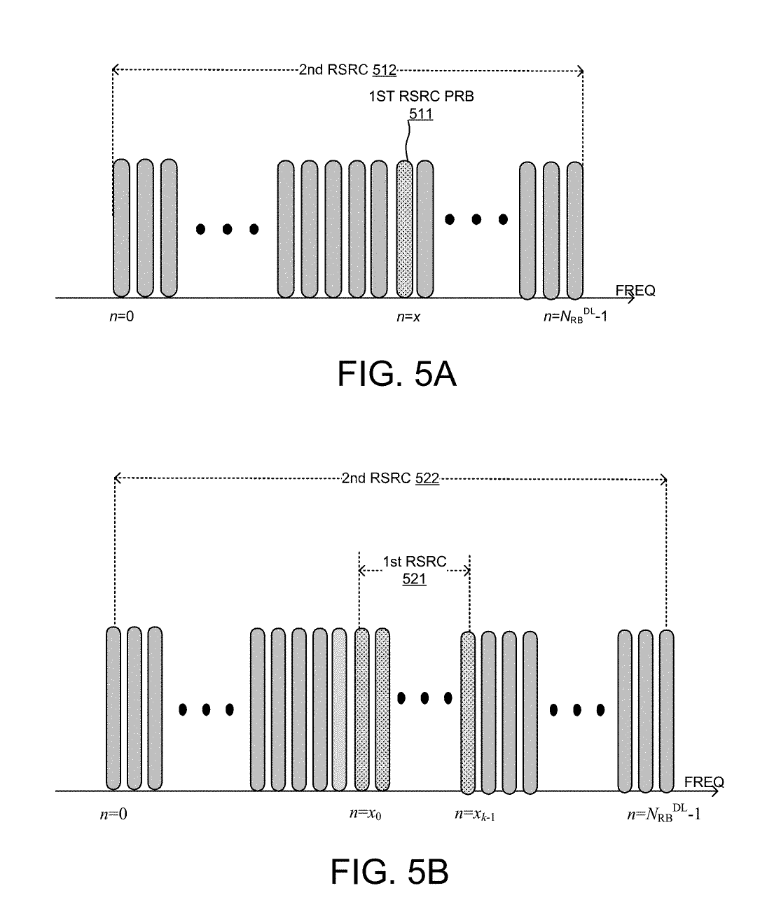

FIG. 5A illustrates an exemplary diagram of DL transmission format with a single resource PRB in accordance with embodiments of the current invention. In this case, the first system could be the NB-IoT system, and the second system could be the LTE system. The resource 512 of LTE system has PRB index of n=0, 1, . . . , N_{RB}^{DL}−1. N_{RB}^{DL} is the number of DL PRB. In NB-IoT system, for example the resource block 511 is in the in-band operation mode of LTE system. The PRB index for the LTE system is x (n=x). The UE determines the PRB index for the LTE system based on the format indicator, which indicates the PRB index x as being the second resource.

FIG. 5B illustrates an exemplary diagram of DL transmission format with multiple resource PRBs in accordance with embodiments of the current invention. In this case, the first system 511 could be the NB-IoT system, and the second system 512 could be the LTE system. The resource blocks of the second system has PRB index of n=0, 1, . . . , N_{RB}^{DL}−1. N_{RB}^{DL} is the number of DL PRB. The resource blocks 521 for the first system occupies k PRBs, whose index is x₀, . . . , xₖ₋₁. The k PRBs maybe consecutive or non-consecutive PRBs, that is 0≤x₀, . . . , xₖ₋₁≤N_{RB}^{DL}−1. For in-band operating mode, the synchronization signals of the first system may occupy one or more PRBs of the second system. In one embodiment, the synchronization signal occupies the consecutive frequency resources. The UE obtains the PRB index by detecting indicator for the DL transmission format. Based on the PRB index, other information may be needed to generate the pilot signals of the PRB location of the first system. The additional information carried in indicator for the DL transmission format may include the synchronization signals (Cell ID), time slot index, symbol index, CP type, etc.

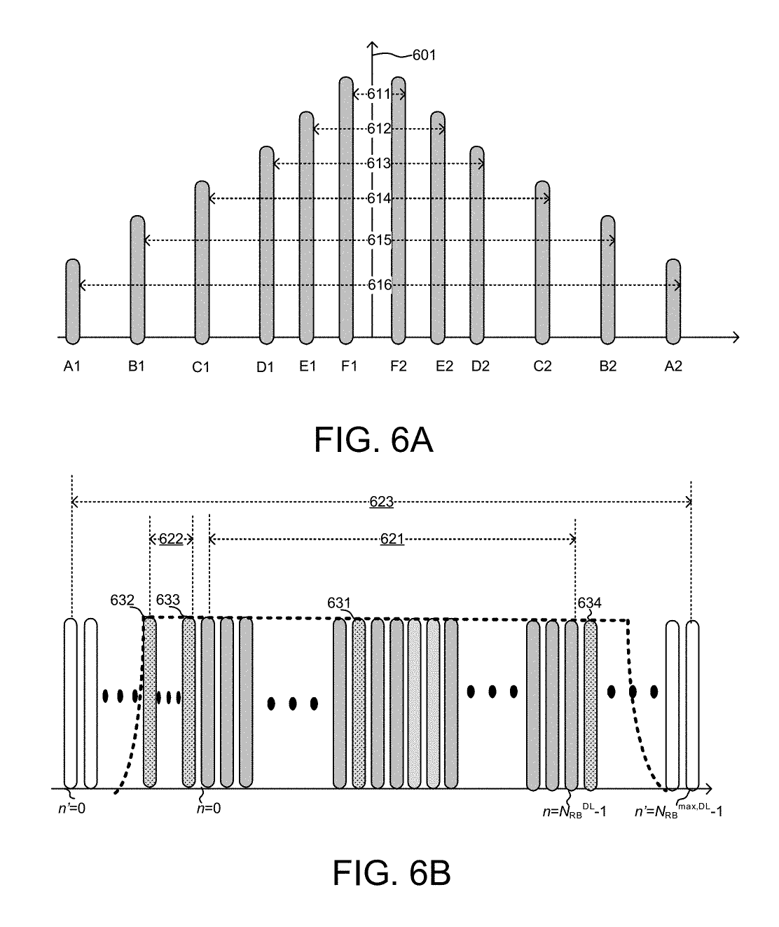

FIG. 6A illustrates an exemplary diagram of DL transmission format in accordance with embodiments of the current invention. The first system could be in-band operation mode, guard band operation mode, or standalone operation mode of the second system. Since the UE may find the format indicator in the anchor frequency of the first system, the UE needs to find the anchor frequency first. In one embodiment, the UE finds the anchor frequency information in the stored UE information, such as the anchor frequency information, the carrier frequency information, and the bandwidth information in the SIM card. In another embodiment, the UE does not know the allocation information of the anchor frequency. Therefore, the UE needs to perform scanning in frequency domain. In one embodiment, based on the power detection in the frequency domain, the UE may find the anchor band in the guard-band of the second system; or find the anchor band in the non-operating LTE band. If UE obtains information related to the central frequency, the UE may reduce the efforts in searching the anchor frequency.

In one embodiment, the UE needs blindly detecting twelve possible regions in the guard band of every potential central band of the second system. If the DL cell BW is known, the potential regions are reduced to two. UE may search power in frequency domain and estimate the DL bandwidth to reduce the regions of scanning. In another embodiment, the UE selects the most possible region in the twelve regions. In one embodiment, UE may find the most possible anchor frequency by the obtaining the RSSI of the twelve regions with different BW. The UE selects two pairs that has the maximum RSSI difference among the guard band pairs of {A1, A2}, {B1, B2}, . . . , {F1, F2}, including 611, 612, 613, 614, 615, and 616. Subsequently, the UE selects the one with stronger guard band power of the selected pair. For example, if the max RSSI is {C1, C2}, wherein, BW=5 KHz. The UE, subsequently, selects the stronger guard band is C2 as the most likely anchor frequency. The person skilled in the art understands that the UE may monitor more PRB pairs to reduce the probability of false alarm.

FIG. 6B illustrates an exemplary diagram of cell search for the first system in guard band of the second system in accordance to embodiments of the current invention. The first system, such as the NB IoT or NB LTE, the second system is the LTE system. The operation mode of the first system is the guard-band mode. The max DL BW 623 is defined as N_{RB}^{max,DL} PRBs, wherein the index is defined as n′=0, . . . , N_{RB}^{max,DL-1}. The BW 621 of the second system 601 is N_{RB}^{DL}PRBs, wherein the index is defined as n=0, 1, . . . , N_{RB}^{DL}−1. The relationship between the above two index is: n′=n+N_{RB}^{max,DL}/2−N_{RB}^{DL}/2. The first system is in the guard band operating mode, occupy the k PRBs of the guard band of the second system guard band. The resource 622 for the first system occupying from PRB 632 with an index n′=−k−2+N_{RB}^{max,DL}/2−N_{RB}^{DL}/2 to PRB 633 with an index n′=−1+N_{RB}^{max,DL}/2−N_{RB}^{DL}/2. In another embodiment, the first system is in band operating mode, the resource of the first system occupy n=s of PRB 631 of the second system BW, wherein index n′=s+N_{RB}^{max, DL}/2−N_{RB}^{DL}/2. Please note that, in band operating mode also may occupy multiple PRBs. In yet another embodiment, the first system is in the guard band operating mode, the resource of the first system occupy PRBs 634 index as n′=N_{RB}^{max,DL}/2−N_{RB}^{DL}/2, PRB 634 of the second system.

There are multiple system BWs in LTE system, for example 1.4 MHz, 3 MHz, 5 MHz, 10 MHz, 15 MHz, and 20 MHz, corresponding to N_{RB}^{DL} 6, 15, 25, 50, 75, and 100 PRB respectively. The max BW of LTE system is defined as N_{RB}^{max,DL}=110 PRB. The UE could not obtain the system BW before decoding the PHY broadcast channel (PBCH), while the PBCH is demodulated based on cell-specific reference signals (CRS). To avoid the blind decoding to obtain information from the PBCH, CRS pilot sequences are designed to have the same pilot sequences for the center six PRBs. CRS pilot signals are generated based on the maximum DL bandwidth. In particular, the pilot signals r_{l,n}_{ₛ}(m) are defined as:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , m = 0 , 1 , … , 2 {N}_{RB}^{max , DL} - 1 \qquad ( 1 )$$

wherein, nₛ is the number of the time slot in a frame, l is the number of OFDM symbols in one the time slot. c(i) is Pseudo random sequence. pseudo random sequence generator is needed before every OFDM symbol, according to cᵢₙᵢₜ=2¹⁰·(7·(nₛ+1)+l+1)·(2·N_{ID}^{cell}+1)+2·N_{ID}^{cell}+N_{CP}, wherein N_{ID}^{cell} is the

$${N}_{CP} = \{ \begin{matrix}1 & normal n CP \\ 0 & extended n CP\end{matrix} \qquad ( 2 )$$

Wherein, pilot signals r_{l,n}_{ₛ}^{(m)} are mapped to complex values modulation symbols a_{k,l}^{(p)} according to a_{k,l}^{(p)}=r_{l,n}_{ₛ}^{(m′)}, and used in the pilot signals in the nₛ time slot, antenna p, wherein

$$k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} \qquad ( 3 )$$

The variables v and v_{shift} are used to define the different frequency locations of the pilot signals, wherein:

$$v = \{ \begin{matrix}0 & if p = 0 n l = 0 \\ 3 & if p = 0 n l \neq 0 \\ 3 & if p = 1 n l = 0 \\ 0 & if p = 1 n l \neq 0 \\ 3 ( {n}_{s} mod 2 ) & if p = 2 \\ 3 + 3 ( {n}_{s} mod 2 ) & if p = 3 \end{matrix} \qquad ( 4 )$$

wherein, v_{shift}=N_{ID}^{cell} mod 6 is the cell-specific frequency offset.

According to the above equation, the UE obtains the pilot location, and pilot signals based on the pilot location by the PRB index equation(3) is used to calculate the m′ pilot location, according to N_{RB}^{max,DL} PRB index defined by the max DL bandwidth, obtained directly, which is m′=2n′. Accordingly, the UE obtains r_{l,n}_{ₛ}^{(m′)}. Due to the limited number of system bandwidth in LTE system, UE may obtain the pilot sequences by blind decoding to determine the PRB index. In one embodiment, for guard band operating mode, synchronization signals of the first system, which is the anchor, are in the PRB of the adjacent locations of second system BW N_{RB}^{DL}, the PRB index is n′=N_{RB}^{max,DL}/2−N_{RB}^{DL}/2. Due to the limited number of value of N_{RB}^{DL}, 6, 15, 25, 50, 75 or 100, the UE could try several values by blind decoding, to obtain the PRB index, which transmitting the first system synchronization signals. The rule could be predefined and should be known to UEs. In another example, the synchronization signals of the first system is transmitted on the adjacent resource to the second system BW N_{RB}^{DL} on the other side of 633, the PRB index is n′=−1+N_{RB}^{max,DL}/2−N_{RB}^{DL}/2. The UE also may perform blindly detecting to obtain or transmit the synchronization signals of the first system on the two ends of any PRB. The UE needs twice the blindly detection complexity to obtain the PRB index. The UE does not store the frequency point information when detecting. The said blind detecting is performed after locking up the synchronization signal of the PRB index. The UE performs blindly detecting the DL physical channel carrying the indicator, or performs blindly detecting of other DL physical channels, and further performs blindly measurement. The blind detecting of the PHY channel is performed according to the assumed pilot.

Similarly, for the in-band operating mode, the PRB index may be predefined to reduce complexity of UE blindly detecting. In one embodiment, it is predefined to transmit the synchronization signals of the second system on the PRB index n′=N_{RB}^{max,DL}/2−N_{RB}^{DL}/2.

Further, if the PRB index of the first system synchronization signals is predefined, the synchronization signal of the first system are in band operation mode or guard band operating mode, the UE may obtain the PRB index by blind decoding, to induce the operating mode as in band or guard band. For the standalone operating mode, the pilot signals could be used to generate the transmission format. In one embodiment, the standalone operating mode generates pilot signals according to PRB index n′=N_{RB}^{max,DL}/2. If the pilot signals abbey the in band operating mode and guard band operating mode by the same rule, and PRB index could be different, so UE may blindly detect the PRB index to determine the operating mode by the PRB index as in band operating mode or guard band.

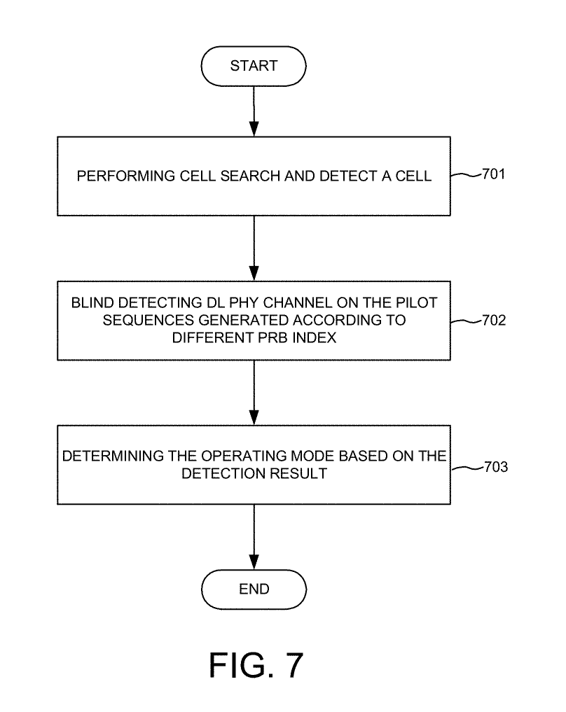

FIG. 7 illustrates an exemplary flow chart of the UE determining the operation mode in accordance with embodiments of the current invention. At step 701, the UE performs cell search and detects a cell. At step 702, the UE blindly detects the DL physical channel according to the pilot sequences generated by different PRB index. At step 703, the UE determines the operating mode based on the detecting result. In embodiment, the DL PHY channels with the synchronization signals occupy the same or different frequency resources. After detecting the synchronization signals by the UE, the UE analyses the format indicator. Subsequently, the UE decodes the format indicator to obtain the DL PHY channel resource information based on the predefined rule, or the format indicator, or a combination of the predefined rule and the format indicator. In other words, the synchronization signals may be used as an anchor to access the system. Subsequently, the UE may performs frequency hopping to other frequency points to perform DL PHY channel receiving. Generally, the transmission frequency location of the DL PHY channel of the second system could be in the any frequency location of the first system.

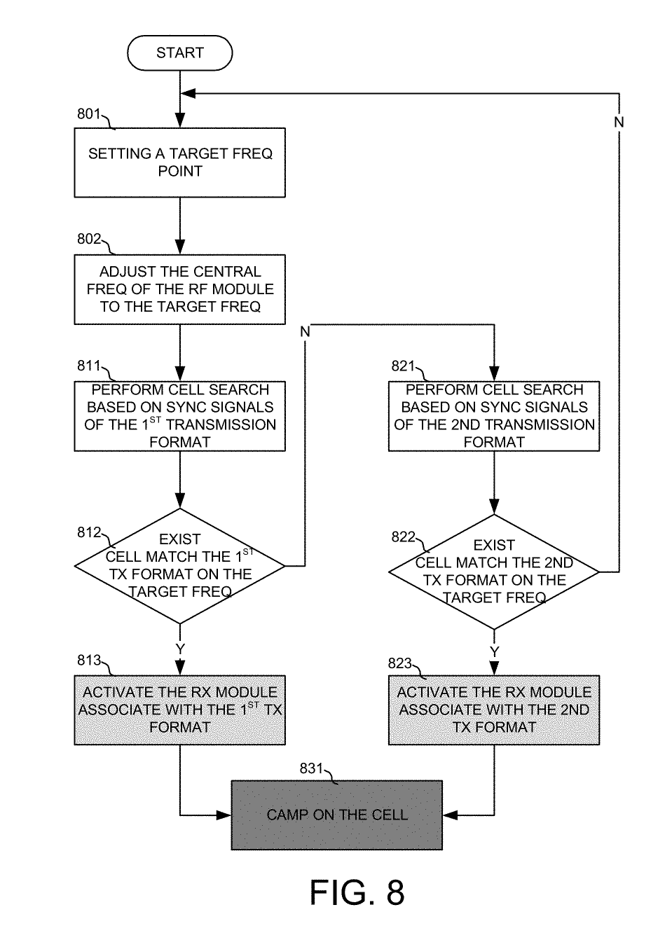

FIG. 8 illustrates an exemplary flow chart of the UE determining the operation mode based on the format indicator carried in the synchronization signal in accordance with embodiments of the current invention. At step 801, the UE obtains a target frequency point, or sets a target frequency point. At step 802, the UE adjusts the central frequency of the radio frequency (RF) module to the target frequency point. At step 811, the UE performs a cell search based on synchronization signals of the first DL transmission format. At step 812, the UE determines whether there is a cell matching the first DL transmission format on the target frequency point. If step 812 determines yes, the UE moves to step 813 and activates the RF receiving module associated with the first transmission format. The UE, subsequently, moves to step 831 and camps on the cell. If step 812 determines no, the UE moves to step 821 and performs a cell search based on synchronization signals of the second DL transmission format. At step 822, the UE determines whether there is a cell matching the second DL transmission format on the target frequency point. If step 822 determines yes, the UE moves to step 823 and activates the RF receiving module associated with the second transmission format. The UE, subsequently, moves to step 831 and camps on the cell. If step 822 determines no, the UE moves back to step 801 by resetting the target frequency point and repeats the procedure. In one embodiment, the UE determines if there is a cell on the target frequency point according to the measurement result. In another embodiment, after UE activates the corresponding receiving module associated with the DL transmission format, the UE performs measurement to determine if the measurement result meets one or more criteria. If yes, the UE camps on the cell. If no, the UE resets a target frequency point to repeat the searching procedure. The one or more criteria and one or more associated parameters may be predefined. The one or more criteria could be rules based using parameters obtained from system information. In one embodiment, the said criterion may be the current S-criterion in LTE system.

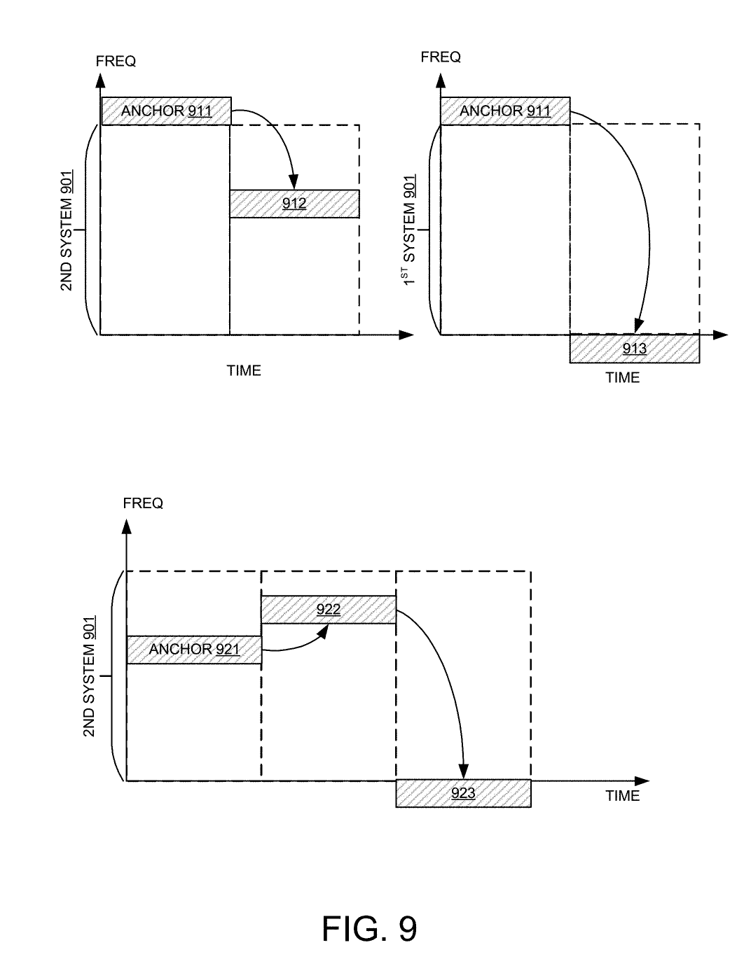

FIG. 9 shows exemplary diagrams of the UE accessing the system through the anchor frequency with frequency hopping in accordance with embodiments of the current invention. In one embodiment, please refer to FIG. 9A, the UE accesses the first system through the anchor frequency 911 of the second system. Anchor frequency 911 is in the guard-band of the second system. Subsequently, the UE may hop to an in-band frequency 912. In another embodiment, the UE accesses the first system through the anchor frequency 911 of the second system, which is the guard band of the second system. Subsequently, the UE may hop to another guard band frequency 913. In yet another embodiment, the UE accesses the first system through the anchor frequency 921. Anchor frequency 921 is an in-band frequency of the second system. Subsequently, the UE may hop to another in-band frequency 922. Further, the UE hops to another in-band frequency 923. The same rules apply to DL PDSCH. The eNB can dynamically adjust the transmission within the frequency band by selecting different frequency points for the UE. The UE obtains the frequency points by decoding the DL control signals. For PDCCH or EPDCCH, the eNB can adjust the frequency semi-dynamically such it can use different frequency points for transmission. The UE obtains the frequency point semi-dynamically. In yet another embodiment, the UE determines the frequency points for frequency hopping based on predefined rule or semi-dynamically updated parameters.

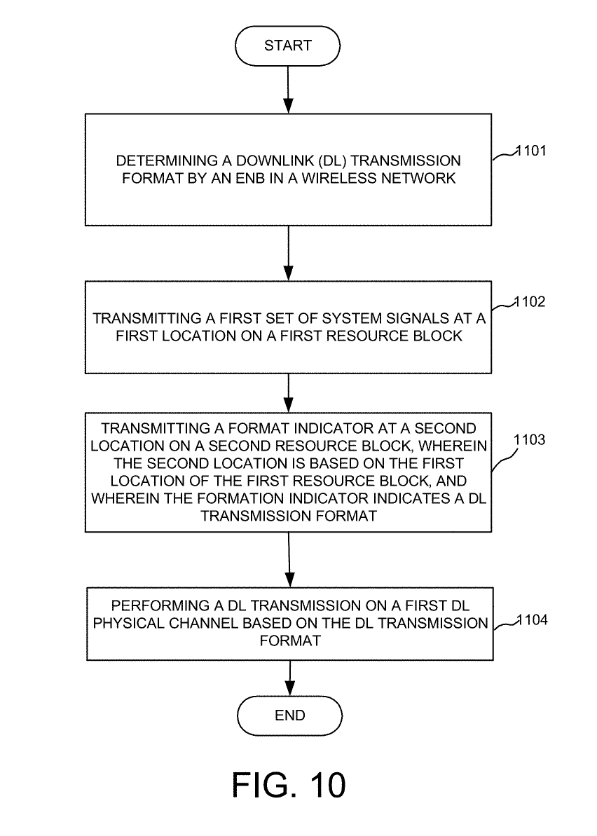

FIG. 10 illustrates an exemplary flow chart of the eNB transmitting DL signals and determining DL transmission format in accordance with embodiments of the current invention. At step 1101, the eNB determines a downlink (DL) transmission format in a wireless network. At step 1102, the eNB transmits a first set of system signals at a first location on a first resource block. At step 1103, the eNB transmitting a format indicator at a second location on a second resource block, wherein the second location is based on the first location of the first resource block, and wherein the formation indicator indicates a DL transmission format. At step 1104, the eNB performs a DL transmission on a first DL physical channel based on the DL transmission format. If eNB support the first system and the second system, the eNB could performs step 1101-1004. For the eNB only support first system, not the second system, eNB could only perform step 1101.

For eNB, the same methods could be used to indicate the UL transmission format. The eNB determines UL transmission format for UE, accordingly, generates the indicator, and eNB adjusts the receiver to receive the UL transmission format UE by the UL transmission format. Different carrier or different BW may be adopted in different transmission ways, so eNB may determine DL transmission format according to carrier frequency. For example, 200 kHz BW is used for the stand alone deployment. Accordingly, DL transmission format adoptes a different one, for example 3.75 kHz carrier spacing, and long CP. In order to reduce the sampling frequency of eNB and UE, to reduce the cost of hardware, calculation complexity, and power consumption, eNB and UE could use the same transmission mode, for example, DL transmission mode and UL transmission mode is the same.

For the convenience of UE detecting, and to avoid the unnecessary blind decoding, cell synchronization signal and indicators adopt the same signals waveform transmission. These transmission waveforms are predefined, which means transmission of the synchronization signal and the transmission of indicators are known to UEs. For example, multiple tone or single tone modulation scheme, carrier or sub-carrier spacing. Besides, UE detects synchronization signal by blind decoding according to synchronization signal location, to obtain the second resource block which the eNB transmits the indicator, and detects indicator on the second resource block.

In another embodiment, UE performs cell search, and to detect the cell ID from the synchronization signal, in the meanwhile to determine DL transmission format, according to the synchronization signal. For example, synchronization signal themselves carry information to determine DL transmission format indicator. In another embodiment, UE may detect synchronization signal to induce the DL transmission format. For example, based on the relative location of two synch signal to determine the DL transmission format. In another case, based on the different scrambling sequences to differentiate the synchronization signal of different DL transmission format. UE performs detection on the synchronization signal according to scrambling sequence which the cell uses, to obtain the DL transmission format which the cell uses.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
retrieving an identification (ID) from a mobile device by a user equipment (UE) in a wireless network;
sending a subscription request to a e-SIM platform, wherein the subscription request includes information of the retrieved ID of the mobile device;
receiving subscription response from the e-SIM platform; and
enabling the mobile device based on the received subscription response.

2. The method of claim 1, wherein the first set of system signals is for cell search.

3. The method of claim 2, wherein the first resource block comprises PSS and SSS, and the second resource block comprises MIB.

4. The method of claim 1, wherein the first resource block comprises PSS, and the second resource block comprises SSS.

5. The method of claim 2, wherein the first resource block comprises PSS and SSS, and the second resource block comprises a signal from a pre-defined set wherein each signal of the predefined set is associated with one DL transmission format.

6. The method of claim 1, wherein obtaining the format indicator on the second resource block by sequence detection within a pre-defined sequence set, where each sequence is associated with one DL transmission format.

7. The method of claim 1, wherein obtaining the format indicator on the second resource block by energy detecting on the second resource block.

8. The method of claim 1, wherein obtaining the format indicator on the second resource block by decoding a second DL channel transmitting carrying system information on the second resource block.

9. The method of claim 1, wherein the DL transmission format includes one or more elements comprising: an operation mode, a DL carrier spacing, a PRB index, a frame structure, a CP length, a transmission waveform, a pilot format, and an operating bandwidth.

10. The method of claim 9, wherein the operation mode is one predefined format comprising a standalone mode, an in-band mode, and a guard-band mode.

11. The method of claim 9, wherein for the in-band mode, the first resource block carrying the first set of system signal(s) for the first system resides inside a frequency band of a second system.

12. The method of claim 9, wherein for the guard-band mode, the first resource block carrying the first set of system signal(s) for the first system resides in a guard frequency band a second system.

13. The method of claim 9, wherein the operation mode is the in-band mode or the guard-band mode, and wherein the DL transmission format further comprising an offset index from a center frequency of a second system.

14. The method of claim 1, wherein after determining a downlink (DL) transmission format, adjusting the configuration of receiver, and receiving and decoding a first DL physical channel.

15. An user equipment (UE), comprising:
a radio frequency (RF) transceiver that transmits and receives radio signals in the wireless communication network;
a first resource block circuit that obtains a first resource block by performing a cell search, wherein the first resource block carries a first set of system signals;
a second resource block circuit that obtains a second location of a second resource block based on the first resource block, wherein the second resource block includes a format indicator;
a downlink (DL) transmission format circuit that determines a DL transmission format based on the format indicator; and
a physical channel circuit that receives and decodes a DL physical channel based on the DL transmission format.

16. The UE of claim 15, wherein the first resource block comprises PSS and SSS, and the second resource block comprises MIB.

17. The UE of claim 15, wherein the first resource block comprises PSS, and the second resource block comprises SSS.

18. The UE of claim 15, wherein the first resource block comprises PSS and SSS, and the second resource block comprises a predefined signal from a pre-defined set, wherein each signal is associated with a DL transmission format.

19. The UE of claim 15, wherein the DL transmission format includes one or more elements comprising: an operation mode, a DL carrier spacing, a PRB index, a frame structure, a CP length, a transmission waveform, a pilot format, and an operating bandwidth.

20. The UE of claim 15, wherein the operation mode is one predefined format comprising a standalone mode, an in-band mode, and a guard-band mode.

21. The UE of claim 20, wherein for the in-band mode, the first resource block carrying the first set of system signal(s) for the first system resides inside a frequency band of a second system.

22. The UE of claim 20, wherein for the guard-band mode, the first resource block carrying the first set of system signal(s) for the first system resides in a guard frequency band a second system.

23. The UE of claim 20, wherein the operation mode is the in-band mode or the guard-band mode, and wherein the DL transmission format further comprising an offset index from a center frequency of a second system.
